(19) United States
(12) Patent Application Publication
(10) Pub. No.: US 2011/0121570 A1
(43) Pub. Date: May 26, 2011

(54) SYSTEM AND METHOD FOR CONTROLLING A TETHERED FLYING CRAFT USING TETHER ATTACHMENT POINT MANIPULATION

(76) Inventors: Joeben Bevirt, Santa Cruz, CA (US); Matthew T. Peddie, Santa Cruz, CA (US)

(21) Appl. No.: 12/819,163

(22) Filed: Jun. 18, 2010

Related U.S. Application Data
(63) Continuation-in-part of application No. 12/456,694, filed on Jun. 19, 2009.
Application No. 12/456,694 is a continuation-in-part of application No. 12/459,017, filed on Jun. 25, 2009.
(60) Provisional application No. 61/236,521, filed on Aug. 24, 2009.
(60) Provisional application No. 61/258,177, filed on Nov. 4, 2009.
(60) Provisional application No. 61/267,430, filed on Dec. 7, 2009.

(51) Int. Cl. F03D 7/00; F03D 9/00; B64C 31/06

(52) U.S. Cl. 290/44; 244/155 A

(57) ABSTRACT

A tethered airborne electrical power generation system which may utilize a strutted frame structure with airfoils built into the frame to keep wind turbine driven generators which are within the structure airborne. The primary rotors utilize the prevailing wind to generate rotational velocity. Electrical power generated is returned to ground using a tether that is also adapted to fasten the flying system to the ground. The flying system is adapted to be able to use electrical energy to provide power to the primary turbines which are used as motors to raise the system from the ground, or mounting support, into the air. The system may use an attachment mechanism for the tether adapted to move the tether attachment point relative to the flying craft.

### CROSS REFERENCE TO RELATED APPLICATIONS

This application is a continuation in part of U.S. patent application Ser. No. 12/456,694 to Bevirt, filed Jun. 19, 2009, which is hereby incorporated by reference in its entirety. This application is a continuation in part of U.S. patent application Ser. No. 12/459,017 to Bevirt, filed Jun. 25, 2009, which is hereby incorporated by reference in its entirety. This application claims priority to U.S. Provisional Patent Application No. 61/236,521 to Bevirt, filed Aug. 24, 2009, which is hereby incorporated by reference in its entirety. This application claims priority to U.S. Provisional Patent Application No. 61/258,177 to Bevirt, filed Nov. 4, 2009, which is hereby incorporated by reference in its entirety. This application claims priority to U.S. Provisional Patent Application No. 61/267,430 to Bevirt, filed Dec. 7, 2009, which is hereby incorporated by reference in its entirety.

### BACKGROUND

1. Field of the Invention

This invention relates to power generation, and more specifically to airborne wind-based power generation.

2. Description of Related Art

Wind turbines for producing power are typically tower mounted and utilize two or three blades cantilevered out from a central shaft which drives a generator, usually requiring step up gearing due to the low rotational speed of the blades.

Some airborne windmills are known in the art. An example of a balloon supported device is seen in U.S. Pat. No. 4,073,516, to Kling, which discloses a tethered wind driven floating power plant.

The generation of electricity from conventional ground based devices has been under study for some time. However, such ground based electrical generation devices are somewhat hampered by the low power density and extreme variability of natural wind currents (in time and space) at low altitudes. For example, typical average power density at the ground is less than about 0.5 kilowatts per square meter (kW/m²). Higher altitudes offer more promising energy densities.

A few hundred meters above the ground, increased wind currents are commonly found. Moreover, in the upper sections of the Earth's boundary layer (at an altitude of about 1 kilometer), relatively stronger winds can be obtained on a fairly consistent basis. Moreover, when very high altitudes are reached, the jet stream is encountered. This is advantageous because jet stream power densities can average about 10 kW/m². Thus, at higher altitudes wind generated power becomes an economically feasible alternative using existing technologies to generate power on an economically sustainable scale. The apparatuses and methods disclosed here present embodiments that can access high altitude wind currents and use the higher energy densities to produce power.

### SUMMARY

A tethered airborne electrical power generation system which may utilize an airfoil based structure with wind turbine driven electrical generators which are attached to the structure airborne. The turbines utilize the prevailing wind to generate rotational velocity. In some aspects, electrical power generated is returned to ground using a tether that is also adapted to fasten the flying system to the ground.

In some aspects, the flying system is adapted to be able to use electrical energy to provide power to the generators which are used as motors to raise the system from the ground, or mounting support, into the air. The system may then be raised into a prevailing wind and use airfoils in the system to provide lift while the system is tethered to the ground. The motors may then resume operation as generators for electrical power generation.

In some aspects, the system may engage in cross-wind flight paths with high speeds and high tether loads. With the increase in tether loading, control surfaces on the airborne craft may not be sufficient to maintain control of the craft through its intended flight path. The tether attachment point to the craft may be manipulated to change the moments about the tether attach point. The manipulation may be made to account for a certain set of flight conditions, or may be made within repetitive flight path cycle.

### BRIEF DESCRIPTION OF THE DRAWINGS

FIGS. 1(a)-1(b) are sketches of an airborne power generation system according to some embodiments of the present invention.

FIG. 2(a)-2(d) are sketches of a flying structure with a bridle according to some embodiments of the present invention.

FIGS. 3(a)-(c) are views of a flying structure with a movable tether attach point according to some embodiments of the present invention.

FIG. 4 is a view of a flying strutted frame structure with wind turbine driven generators according to some embodiments of the present invention.

FIG. 5 is a front view of a flying strutted frame structure with wind turbine driven generators according to some embodiments of the present invention.

FIGS. 6A-B are a front and side view, respectively, of a stationary flight profile according to some embodiments of the present invention.

FIGS. 7A-B are a front and side view, respectively, of a cross-wind flying profile according to some embodiments of the present invention.

FIG. 8 is a perspective view of an airborne power generation system with a front canard according to some embodiments of the present invention.

FIG. 9 is a side view of a power generation system on the ground according to some embodiments of the present invention.

FIGS. 10(a)-10(c) are views of a power generation system with a single airfoil according to some embodiments of the present invention.

FIGS. 11(a)-11(c) are views of a power generation system with two airfoils according to some embodiments of the present invention.

### DETAILED DESCRIPTION

In some embodiments of the present invention, an airborne power generation system is adapted to be built in varying sizes, and to provide differing levels of power, through the use of a modular design. A strutted frame structure design with airfoil sections as part of the frame structure and with wind driven power generation turbines is adapted to be flown while tethered to a ground station. The tether may be adapted to be the structural attachment to the ground and also the electrical power conduit between the frame structure and the ground. The power generation system may be sized using modular aspects of both the structural and electrical design. In some aspects, the strutted frame structure is planar, and in other aspects the strutted frame structure may have multiple planes of struts and airfoil sections. The power generation system may be launched from the ground using vertical take-off with the assistance of ground power.

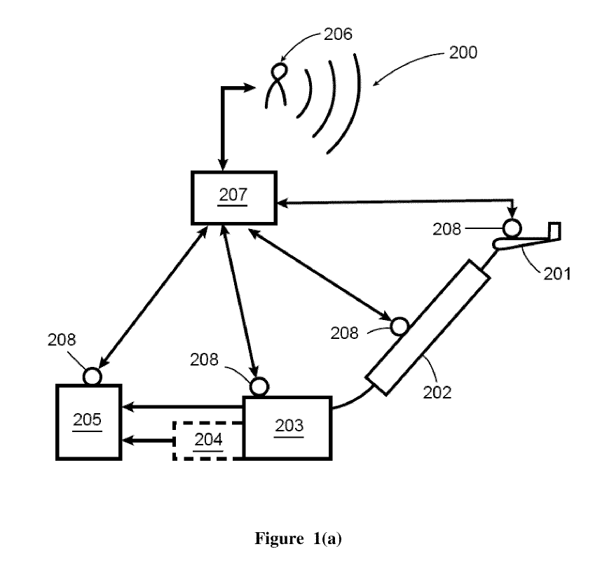

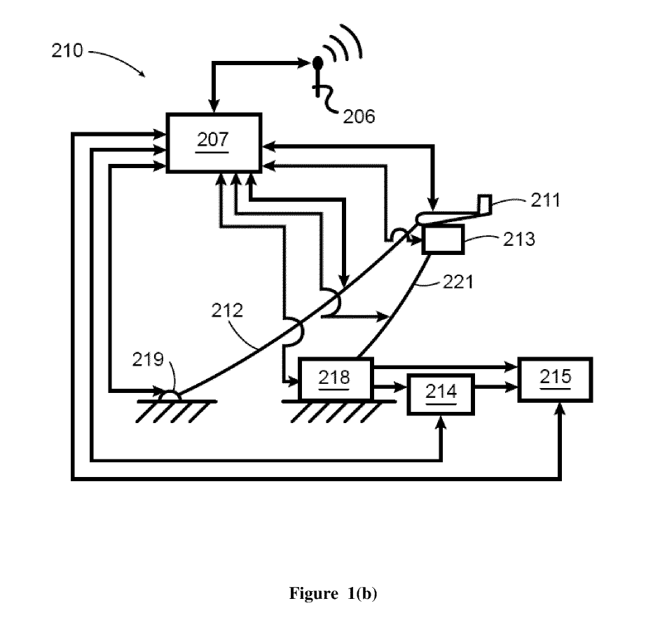

FIG. 1(a) schematically represents an example system enabling energy generation in accordance with the principles of the invention. This system 200 described herein is not intended to be limiting, but rather provides a useful starting place to describe the many attributes of the disclosed invention. The system 200 includes a flyable aircraft 201 that is attached to an energy generation station 203 using a tether 202. Wind energy captured by the craft 201 is transferred to the energy generation station 203 using the tether 202. Generally, forces exerted by the tether 202 are harnessed and used to generate electricity at the generator 203. The system can further include an energy storage system 204 that forms part of the energy generation system 203. In alternative approaches, the energy storage system 204 can be separate from the energy generation system 203. Energy produced by the system 200 or stored 204 can be supplied to a distribution system 205 which can deliver the energy as needed. A typical example of such can be an electrical distribution network or power grid. Also, an atmospheric monitoring system 206 can be included to monitor weather, wind, and flight conditions. Such monitoring can include real-time information as well as forecasting information. The monitoring system can be ground-based, seaborne, airborne, or even space-based. Also, each of the disclosed systems 201, 202, 203, 204, 205, 206 can include sensor devices 208 that monitor the performance of each portion of the system 200 to provide information to a control system 207 that can adjust flight parameters and adapt to varying and changing conditions. This integrated system 200 can be used to among other things, optimize power generation, more efficiently distribute power, enhance system performance, adapt to variations in weather conditions, control the flight profiles of craft, adapt to system needs, local conditions, and a myriad of other performance and optimization information.

Another associated approach for harvesting wind energy applies to airborne wind turbine systems. FIG. 1(b) schematically depicts one such system. This system 210 described herein is not intended to be limiting, but rather provides a useful starting place to describe the many attributes of the disclosed invention. The system 210 includes a flyable aircraft 211 that includes an energy generation system 213 capable of generating electricity. This is commonly a turbine system 213 carried and kept aloft by the aircraft 211. The craft 211 is anchored to the ground 219 using a tether 212. Wind energy captured by the energy generation system 213 of craft 211 is transferred to a ground station 218 using an electrical transmission line 221. In one application the electrical transmission line 221 is supported by the tether 212. In another approach, energy generated can be transmitted to the ground station using an alternative carrier system (e.g., microwave generation and receiving stations). The system can further include an energy storage system 214. Energy produced by the system 210 or stored 214 can be supplied to a distribution system 215 which can deliver the energy as needed. A typical example of such can be an electrical distribution network or power grid. Also, an atmospheric monitoring system 206 can be included to monitor weather, wind, and flight conditions. Such monitoring can include real-time information as well as forecasting information. The monitoring system can be ground-based, seaborne, airborne, or even space-based. Also, each of the disclosed system elements 206, 211, 212, 213, 214, 215, 218, can include sensor devices that monitor the performance of each portion of the system 210 to provide information to a control system 207 that can adjust power generation parameters and flight parameters and adapt to varying and changing conditions. This integrated system 210 can be used to among other things, optimize power generation, more efficiently distribute power, enhance system performance, adapt to variations in weather conditions, control the flight profiles of craft, adapt to system needs, local conditions, power generation concerns, and a myriad of other performance and optimization information.

In one approach a craft or “kite” 201 is attached to a long tether 202 and allowed to gain altitude. As the kite 201 gains altitude it applies forces on the tether. As the force applied by the kite continues, more and more of the tether 202 is played out. The tether can be attached to an energy generator 203 which generates electrical energy as a tether is played out. In a typical embodiment, the generator 203 includes a large reel of tether 202 which spins in one direction as the tether is played out under force generated by wind energy against the “kite” 201. In certain embodiments, the reel (part of the energy generator 203) forms part of an electro-magnetic power generator. During operation as the tether is played out, the reel spins enabling electrical power generation. Periodically, the kite can change its flight profile (e.g., angle of attack or other flight characteristics) to remove tension from the tether. When the tension is removed, the tether can be reeled in using relatively little energy. One method of reeling the kite in employs a small motor. Once the kite is reeled in a desired amount, the kite is maneuvered into a different flight profile enabling the wind generated force to again be applied to the kite. Various flight patterns can be used to effectively generate power. Examples include crosswind flight patterns such as “figure eight” patterns and so on. In any case the playing out and reeling in of the tether can be applied repeatedly for long periods of time enabling extensive power generation. The kites are generally flown at altitudes calculated to obtain the highest efficiencies for energy generation although any altitude can be selected. For example, energy harvesting can be efficient at altitudes as lower as a few hundred meters with certain advantages also accruing at altitudes in the range of a few kilometers (e.g., 1-2 kilometers). However, the devices and systems disclosed herein are not to be confined to operation at any particular altitude. The power generation attributes of these craft can be enhanced by adding ancillary energy generation mechanisms such large solar panels to the craft and/or tethering systems. Also, auxiliary wind turbines can be mounted at various locations on the craft.

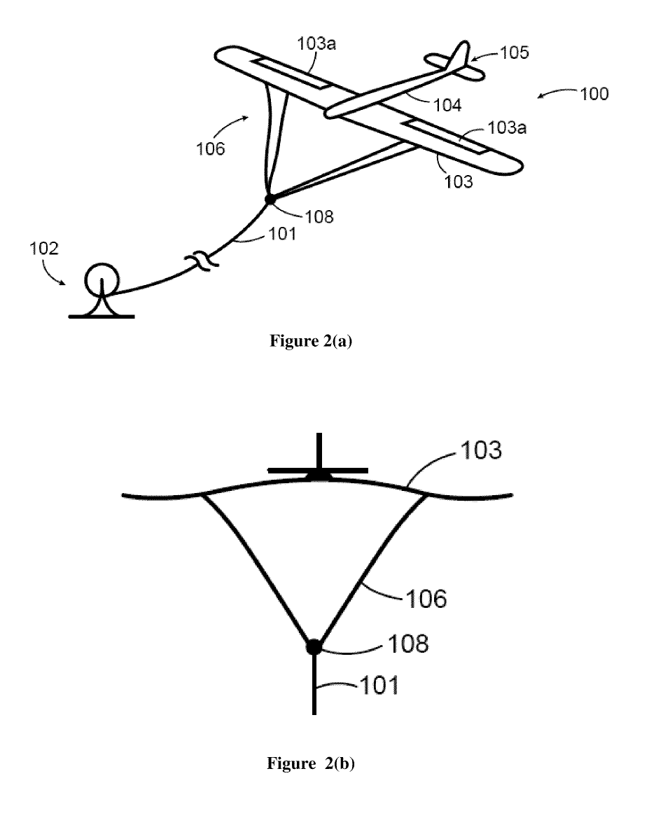

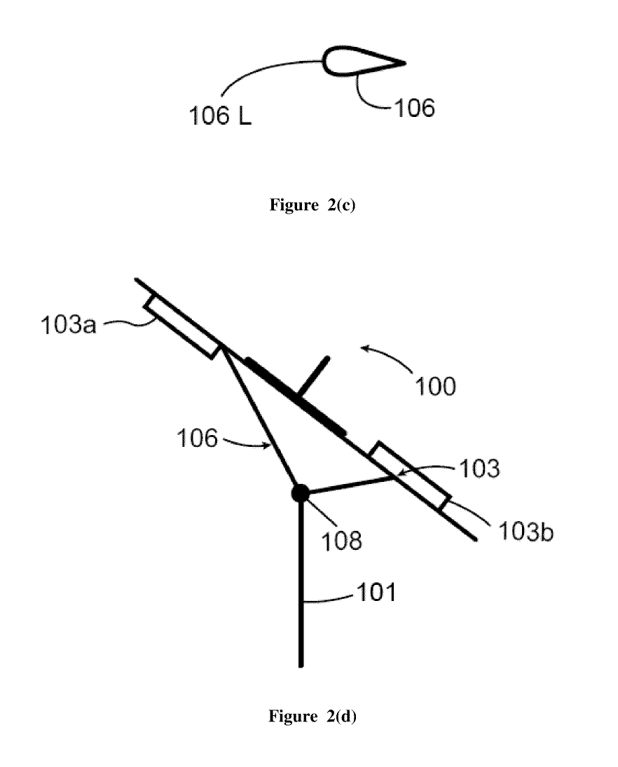

As shown in FIG. 2(a), the inventor contemplates a kite 100 configured to generate wind energy. The kite 100 can be constructed in many different configurations having a wide range of aerodynamic and flight characteristics and properties. Accordingly, the kite 100 depicted here as a substantially aircraft-shaped apparatus should serve as an example, but kites constructed in accordance with the principles of the invention are not limited to the depicted exemplar shape. The kite 100 is attached to a tether 101 which is moored to an energy generator 102 which can be located on the ground. In some embodiments the kite may use an airfoil without tail structure. In some embodiments, the kite may use an airfoil or airfoils with a front canard structure.

In the depicted embodiment, the kite 100 includes a wing 103 mounted to a minimal fuselage 104 which further includes an empennage 105 for added stability. In the depicted embodiment, the tether 101 is attached to the craft using a bridle assembly 106, which in this depiction is affixed to the wings to provide a stable attachment to the craft 100. Many different bridle 106 configurations can be used to secure the craft 100 to the tether 101 and the invention should not be limited to only the depicted embodiments. The inventors contemplate that for enhanced performance the wing 103 of the kite 100 can be configured with ailerons 103a and/or other control surfaces. Additionally, although rigid wings 103 are believed to provide the best performance the inventor appreciates that non rigid wings can be employed in some embodiments.

In some embodiments the kite 100 turns and maneuvers similar to a glider. In other words control surfaces can be used to maneuver the craft 100. In one particular approach, FIG. 2(d) shows the implementation of ailerons 103a, 103b to bank the craft.

The applicants further point out that the bridle can include an articulation mechanism (schematically depicted as 108). This mechanism can be used to enhance or replace portions of the control system to enable the bridle to initiate and control the roll of the craft 100. Additionally, the bridle 106 and mechanism 108 can be configured to alter the angle of attack for the airfoil 103.

With reference to FIG. 2(b), the inventors point out that the bridle 106 can be attached at any point on the airfoil 103. The bridle 106 can be attached at the ends of the airfoil 103 or at points between the tip of the airfoil 103 and the fuselage 104. The depicted embodiment shows a bridle 106 attached at a point inward from the wingtip. This construction enables a lighter and thinner spar to be used in the construction of the airfoil 103. This has the advantage of significantly lowering the drag induced by the wing 103. Also, the inventors contemplate that, as shown in FIG. 2(c), an airfoil shaped bridle 106 can be used. FIG. 2(c) is a cross-section view of a bridle 106 such as shown in FIG. 2. Such a shape provides streamlining and reduced drag. Additionally, the shape can be optimized to provide increased stability to the bridle 106. In the depicted embodiment the leading edge 106L is typically oriented toward the front of the craft 100.

With continued reference to FIGS. 2(a)-2(c) and with further reference to FIG. 2(d), the inventors illustrate that in one embodiment the articulation mechanism 108 enables the bridle 106 to control the roll of the craft 100. It is further contemplated that ailerons 103a can be used to enable roll. Although the inventors specifically contemplate embodiments that do not make use of ailerons 103a. In another embodiment, the articulation mechanism 108 can be used without ailerons of even other control surfaces if desired. In some embodiments, the articulation mechanism 108 can be a pulley or other similar apparatus. A motorized winch apparatus could also be used. The idea being that the pulley is moved toward one wingtip or the other depending on the direction and magnitude of roll desired. In effect, the pulley lengthens one part of the bridle and shortens the other. The depiction of FIG. 2(d) shows a craft 100 as viewed from head on showing the effect when the pulley is moved from the centerline to a direction to the right of the observer. This makes the left side (as viewed from an observer directly ahead) roll upward. A reversed pulley motion causes the opposite effect. In other embodiments the articulation mechanism 108 can also be used alter the angle of attack of the craft 100. For example, because the articulation mechanism 108 is arranged under the center of lift for the airfoil 103 the angle of attack can be relatively easily altered by moving the articulation mechanism 108 forward or backward. The inventor understands that many methods known to those having ordinary skill in the art enable the tether to be moved back and forward as needed. For example, a small motor can be employed and actuated using wireless or wired signal.

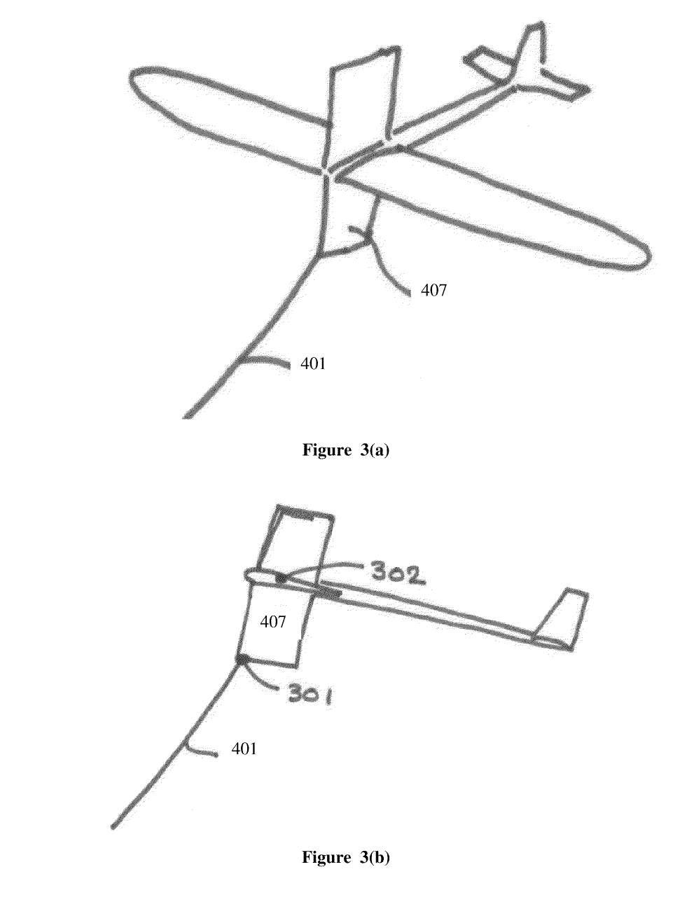

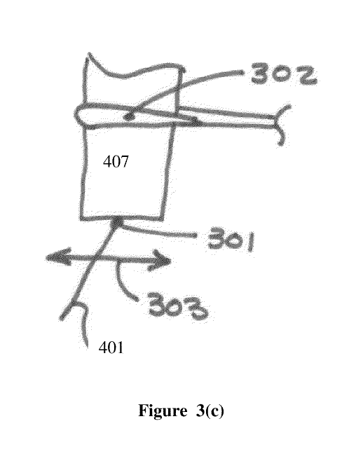

As figuratively depicted in FIG. 3(a), some kite embodiments can incorporate a transverse airfoil 407 to enhance the performance of the kites. Such airfoils 407 can be symmetric or have alternative wing geometries. Additionally, if desired, in such embodiments the tether 401 can be secured to a bottom portion of the transverse airfoil 407. An advantage to such an implementation is shown and described with respect to FIGS. 3(a)-3(c). In one embodiment, the attachment point 301 for the tether 401 can be movable. For example, the attachment point 301 is arranged at a bottom surface of the transverse airfoil 407. Such implementations have the advantage of mounting the tether 401 below the center of lift 301 for the kite 100. In addition to making a stable platform, such mounting enables the tether 401 to affect flight characteristics by moving the attachments point relative to the center of lift 302. By moving the attachment point 303 backward or forward the angle of attack for the wing 103 can be adjusted readily and quickly. The inventor understand that many methods known to those having ordinary skill in the art enable the tether to be moved back and forward as needed. For example, a small motor can be employed and actuated using wireless of wired signal.

In some embodiments, the flying structure is adapted to rest on the ground, or on a support structure, or float on water such that the front of the airfoil sections are facing skyward and the power generation turbines are also facing skywards. In some embodiments, the electrical portion of the system is adapted to receive power via the tether from the ground station and use that power the turbines as engines. The engines can thus raise the strutted frame structure from the ground into the air. The control system may be adapted to first raise the frame structure in a horizontal position and then the frame may be moved to a vertical position, resulting in a tethered position and flying based upon lift of the airfoils. The vertical take-off scenarios are used with single and multi-plane systems. Unlike traditional VTOL systems for aircraft, the multiple rotors allow for a 2 dimensional spacing of the rotors, greatly enhancing the safety and controllability of the system during takeoff and landing. With the rotors spaced in two-dimensions relative to the plane of the ground, differentiation of thrust between the rotors allows for two-axis control of the structure during take-off and landing. The wind turbine driven generators may operate as motor driven propellers during this aspect. In some embodiments, electrical power to power the motors during take-off and landing travels via the tether from the ground station. In some embodiments, the electrical power to power the motors during take-off and landing may come from a battery storage system on the structure itself.

In some embodiments of the present invention, attitude adjustments of the frame structure may be achieved using differential control of the wind turbine driven generators. For example, to increase the angle of attack of the airfoils within the frame structure, the drag on the upper portion of the structure may be increased, and the drag on the lower part of the structure may be decreased, resulting in a “tilt”, or pitching up, of the frame structure. The changes in drag may be due to changing the loading on the power generation turbines such that the turbine rotational speed is lessened or raised. In addition, the attitude of the frame in general may be controlled using this differential control of the various turbines, which in turn allows for position control relative to wind direction, as well as altitude control.

In the case of cross-wind flying paths, or other flying scenarios of the structure, attitude control and position control are used to implement path control of the flying structure. As mentioned above, pitch and yaw control of the structure may be implemented by varying the amount of drag of individual wind turbine driven generators. In some control scenarios, positive thrust may be used at one or more generators (which then become thrusting motors).

In some embodiments, attitude and altitude control may utilize control surfaces on the airfoils or otherwise mounted within the strutted frame structure. In some embodiments, a full sensor system, or portions thereof, resides on the frame structure. Sensors may include altitude sensors, attitude sensors, accelerometers, wind speed sensors, global positioning system monitoring, and other sensors. In some embodiments, the vehicle may include markers for infrared sensing of the structure from the ground or other observation points. In some embodiments, the structure may include on-board cameras to view the flight path, or the horizon, as desired by the control system and/or the user.

The tether used to attach the airborne system to the ground may be used to transmit power as well as being a structural attachment. The tether may be wound around a drum on the ground that is used to reel in and out the tether as well as store the unused portion of the tether. In some embodiments, the main drum which is used to mechanically reel the tether in and out may have a limited number of revolutions of the tether on it, with the remainder of the tether trailing off of this main drum onto a storage drum. This may allow a rotation of the main drum to result in a more uniform amount of tether to be reeled regardless of the altitude of the flying system.

In some embodiments a tether assembly wherein a tether sheath has been placed over a tether may significantly reduce the drag of a tether. For example, using a 0.4 inch diameter tether as an illustrative example, the tether may have a certain drag while experiencing apparent winds. Using as an example a wind direction perpendicular to the tether length axis, a 0.4 inch cylindrical tether may have a drag force in a 35 mph wind of 0.15 pounds per linear foot of tether. At 65 mph, this drag may increase to 0.46 pounds per linear foot. Using a tether sheath with a 0.7 inch maximum thickness, a chord length of 2.85 inches, and with the tether centered at the 20% chord length position, the sheathed tether drag may be 0.034 pounds per linear foot at 35 mph, and 0.062 pounds per linear foot at 65 mph. The drag reduction may be in the range of 80-90%.

Another distinct advantage of the tether sheath is that in some embodiments, the tether sheath may be manufactured in relatively short lengths, and then have the longer tether inserted through it. For example, a tether may be 1000 meters long. There may be advantages to manufacturing the tether, with its structural aspect for tensile loading, and with its electrical conduction aspect, separately from the aerodynamic tether sheath. The tether sheath could thus be manufactured in shorter lengths, in the range of 3-15 meters, and be inserted over the tether after the prior manufacture of both the tether and the sheath.

Tethers and tether sheaths according to embodiments of this invention may be advantageous not only for reduced drag but also for their dynamic effects. For example, a tether sheath may allow for rotation around the tether in a manner which enhances the dynamic stability performance of the system.

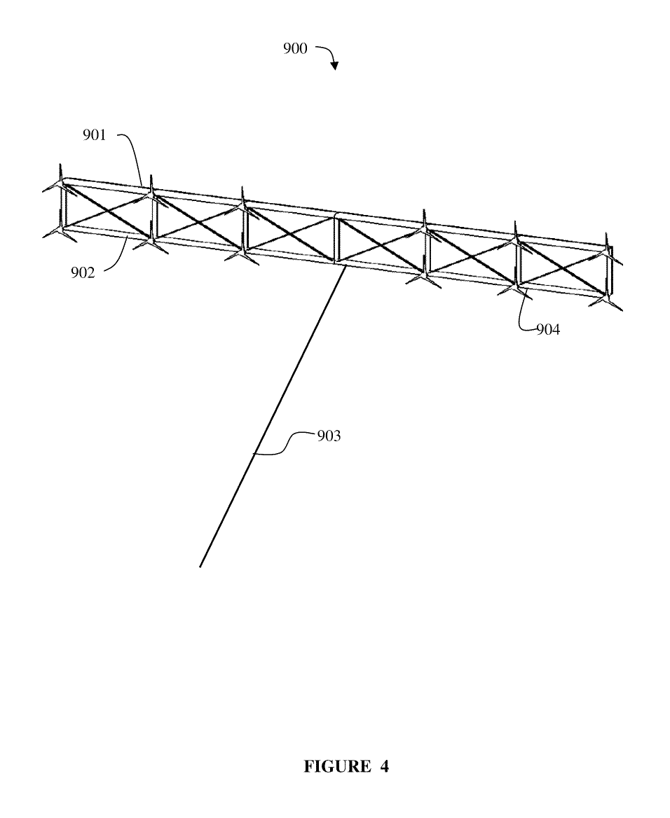

In some embodiments of the present invention, as seen in FIG. 4, an airborne power generation system 900 may have two rows of airfoils 901, 902. The system may be adapted to use a tether 903 with a nominal length of 1000 m. The system may utilize 12 turbine driven generators 904 which are mounted along the two rows of airfoils. The turbines (propellers) may have a diameter of 2.4 m. The nominal total power rating of such a system may be 1 MW. The system may be adapted for flying at 74 meters/second in an 8.5 meters/second ambient wind using a cross wind flight path such as a circular flight path.

The horizontal sections of the frame structure are airfoil elements. Power generation turbines are placed at most of the junctions of the airfoils and cross struts. In some embodiments, the power generation turbines may utilize blades which are pitch controllable. The blade pitch may be controlled with mechanisms at the hub into which the blades are attached. The blade pitch control may allow the blade pitch to be adjusted to allow for better efficiencies depending upon the apparent wind speed at the turbine, as well as limiting rotor speed in high speed winds. The blade pitch control may also allow the drag of a turbine to be altered to allow for attitude control of the strutted frame structure using differential control of the drag of turbines throughout the structure.

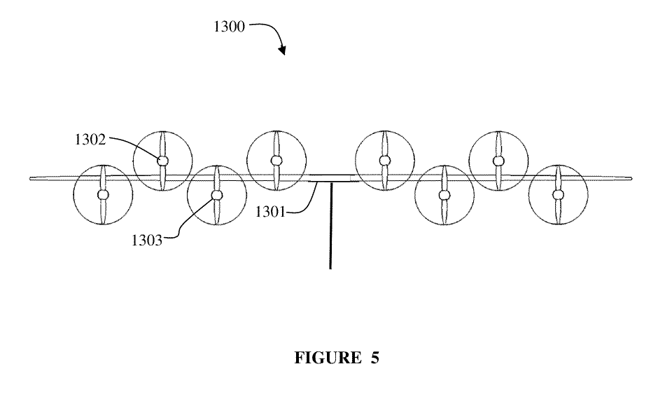

In some embodiments of the present invention, as seen in FIG. 5, a flying frame structure 1300 adapted for airborne power generation may use a single airfoil 1301. The system may use turbine driven generators 1302 above the airfoil 1301 and also generators 1303 which are below the airfoil. The spacing both above and below the airfoil enhances the control of the structure by spacing the thrust/drag elements across two dimensions.

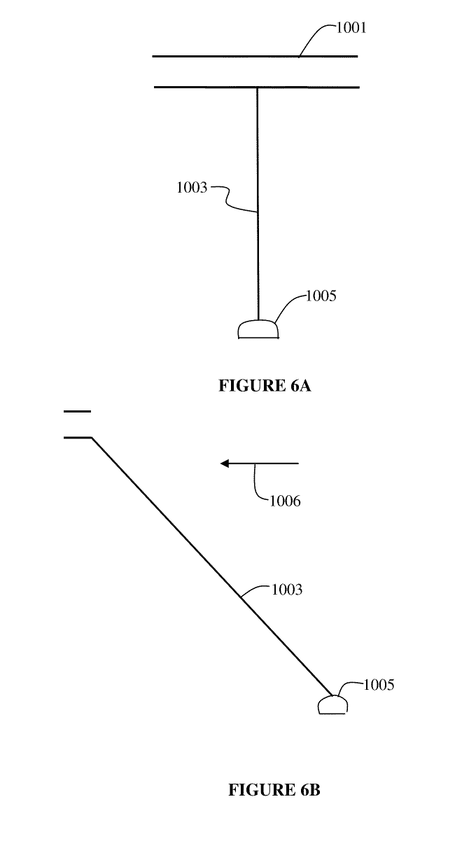

FIG. 6A illustrates a front end view of an airborne system in a relatively stationary airborne mode. FIG. 6B illustrates a side view of an airborne system in a relatively stationary airborne mode.

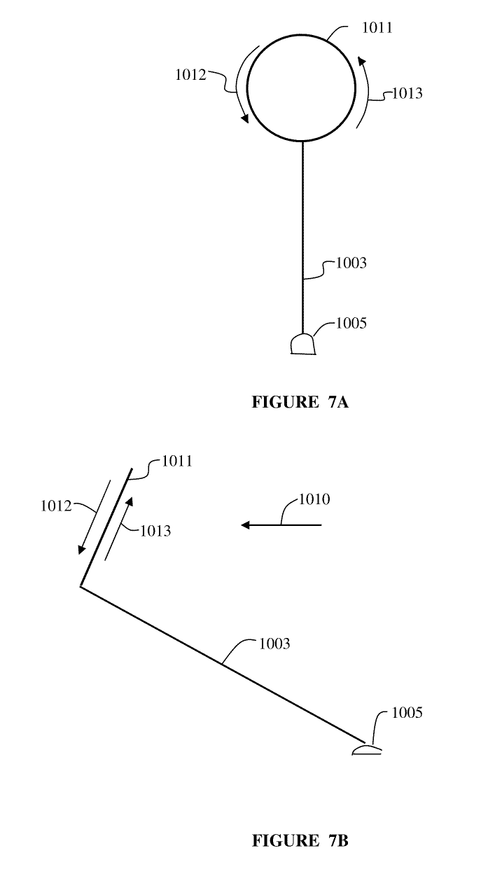

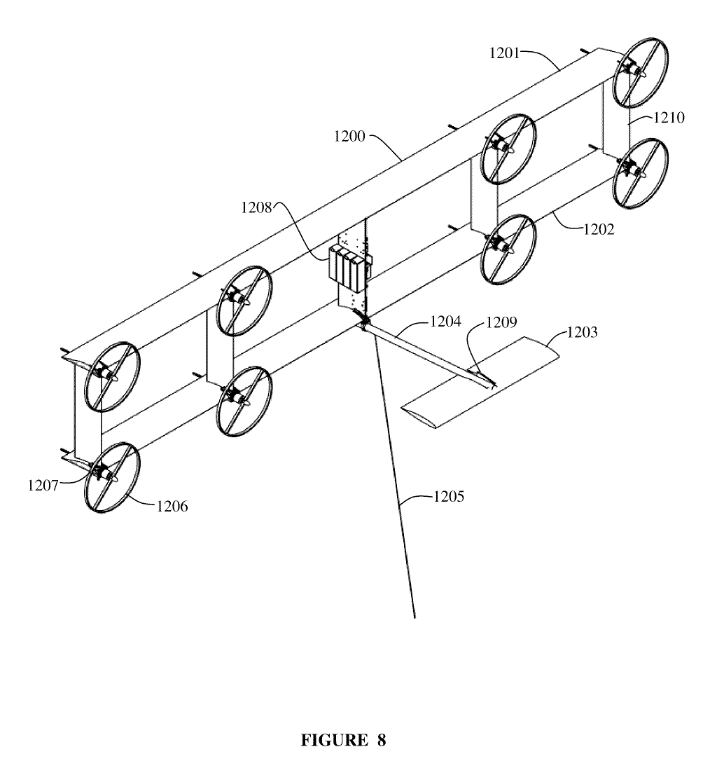

In some embodiments, the airborne power generation system may be flown in an alternate flight paradigm. Cross-wind flying paradigms allow for a higher flight speed, and a higher air flow speed into the power generating turbines. A cross-wind flying paradigm may take on a variety of shapes, such as a FIG. 8, or may be substantially circular. FIGS. 7A and 7B illustrate a front end and side view, respectively, of a circular flying paradigm. Using the power generation system of FIG. 4 as an example, on a 1000 m tether and with an 8.5 meter/second ambient wind 1010, the airborne power generation structure flies in a substantially circular flight path 1011. In such a flight path, the airborne power generation structure may achieve a nominal average flight speed of 74 meter/second of composite apparent wind speed, which is substantially higher than the ambient wind speed. The composite apparent wind speed is the resultant through the turbine from the cross-wind flying speed and the ambient wind speed.

The high speeds which may be achieved during the cross-wind flight paths may be realized using vehicle pitch control which is controlled in part, or in whole, by the use of a front canard. As seen in FIG. 8, an airborne power generation vehicle 1200 includes a front canard 1203 which may be mounted forward of the main part of the vehicle on a canard boom 1204. A top airfoil 1201 and a bottom airfoil 1202 may each have four generators 1207 driven by turbines 1206. In a powered flight scenario, the turbine driven generators may be operated as motor driven propellers. In some embodiments, there may be a bank of electronics 1208.

In airborne flight scenarios, the airborne power generation vehicle 1200 may be tethered to a ground stations with a tether 1205. The tether 1205 may be a combination of a structural attachment and an electrical conduit. The front canard 1203 on the canard boom 1204 may be adjusted in pitch using a canard controlling mechanism 1203.

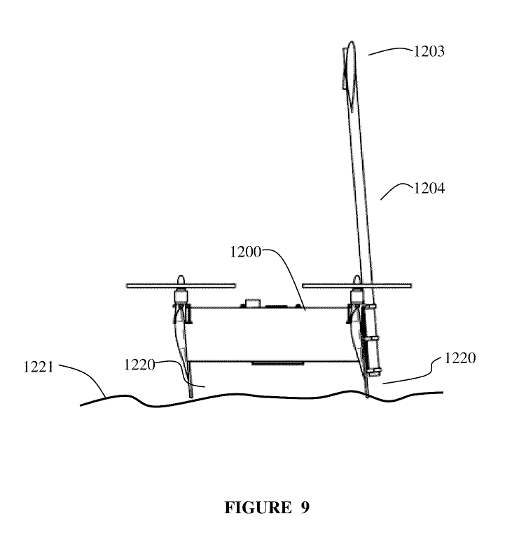

FIGS. 8 and 9 illustrates advantages of an airborne power generation vehicle 1200 with a front canard 1203 with regard to vertical take-off and landing. The airborne power generation vehicle 1200 may be adapted to engage in vertical take-off and landing. The bottom of the vehicle 1200 (which is the rear in regular flight) while on the ground 1221 may reside upon struts 1220. The front canard 1203 and the canard boom 1204 are extended upwards in the take-off position. The front canard configuration blends well with the vertical take-off and landing aspects of the vehicle.

In some embodiments, the entire front canard 1203 is adapted to pivot around an axis parallel to the leading edge of the front canard. The canard controlling mechanism 1203 may pivot the front canard 1203 which in turn will cause a pitch change of the vehicle 1200. FIGS. 9A and 9B illustrate a front view and a top view, respectively, of the airborne power generation vehicle 1200 flown with a front canard 1203.

In flight, the vehicle 1200 may be controlled in pitch using the front canard, or using the front canard in conjunction with other methods described herein.

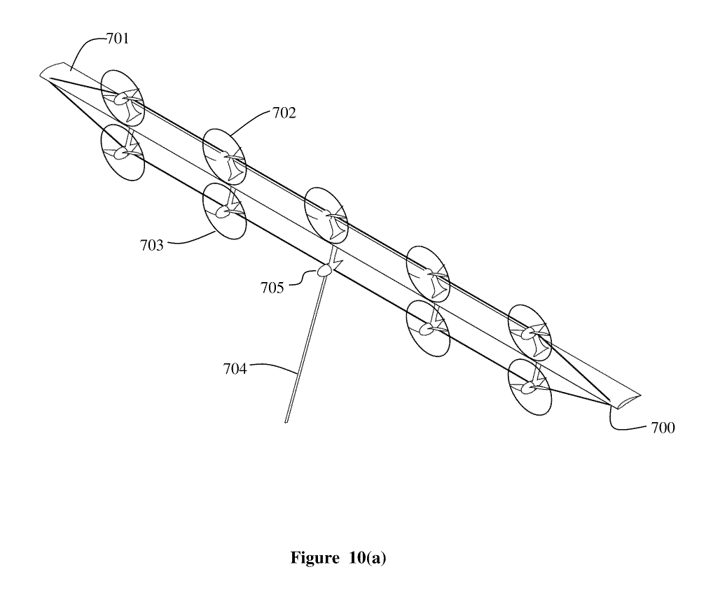

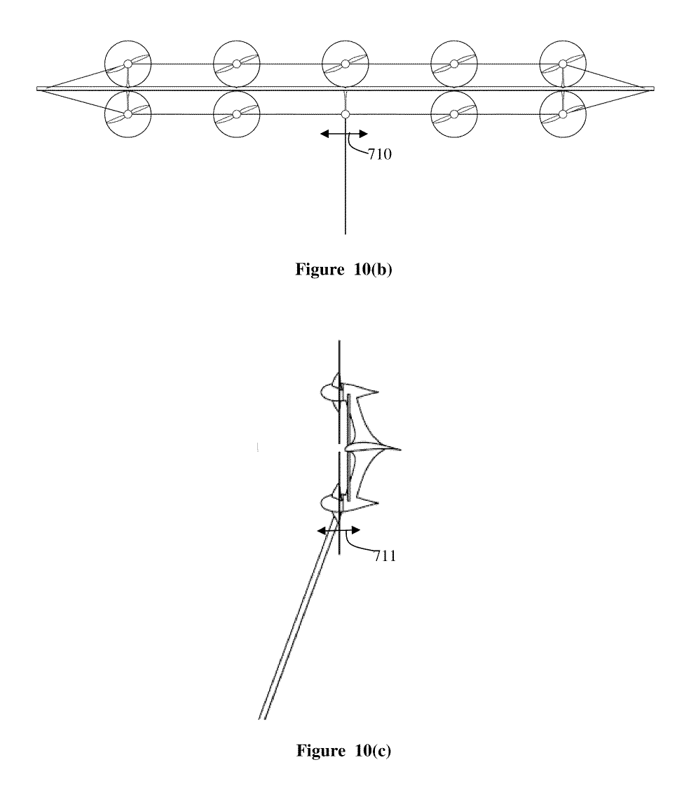

FIGS. 10(a)-10(c) illustrate a single wing power generation system 700 according to some embodiments of the present invention. A tether 704 may be attached to the flying structure at a tether attachment point 705. The airfoil 701 may have a plurality of turbine driven electrical generators 702 above the airfoil 701, and a plurality of turbine driven electrical generators 703 below the airfoil 701. In some embodiments, the tether attachment point 705 is adapted to move the attachment point relative to the overall flying structure. The available movement may be in one axis, two axis, or three axis. In some embodiments, the tether attachment point 705 may use a two axis plate assembly which allows for differential motion using internal lead screws.

Using an illustrative example of the system 700, the system may have a design value of 30 kW. For some flight profiles, it may be desirable to move the tether attachment point from side to side, or from front to back, or both, in order to fly in the desired path. In some embodiments, a change in roll could be realized with ailerons on the airfoil 701, for example, but moving the tether attachment point from side-to-side 710 could allow for a roll change without the increase in drag that may be associated with using the ailerons. Thus, the tether attach point adjustment can be used while still giving the control system the opportunity to use the ailerons as needed.

In the illustrative example of FIGS. 10(a), the nominal tether tension may be 28kN. The airfoil span may be 14.5 meters, and the chord may be 64 cm. The maximum available roll control torque from the ailerons may be 18 kNm, but the use of the ailerons for this torque may add 15% to the drag of the flying vehicle. Thus, it may be advantageous for the system to use tether attach point adjustments. In some embodiments, the tether attachment point may be moved in the range of 1 cm to 1 meter. For roll control, the tether attachment point may be moved side-to-side 710. For pitch control (and for stability as mentioned below), the tether attachment point may be moved front to back 711.

In some embodiments, an airborne power generation system may use a flying airfoil with turbine driven generators flying in a cross-wind flight path. The position of the airfoil long its desired flight path at a given moment may be monitored using a variety of methods, including attitude control sensors, and position sensors. As part of the control of the airfoil in its flight path, the tether attachment point may be moved allow for roll control and pitch control. Given a desired flight path, a flight control system may direct various aspects of the airborne system in order to maintain position, attitude, and speed.

In some embodiments, the tether attachment point may be manipulated within a repetitive flight path cycle, as described above. In some embodiments, the tether attachment point may be set for a particular set of flight conditions, and then maintained. Among the flight conditions which may be included are the power output desired from the system, the wind speed, the altitude, and the flight pattern.

In some embodiments, the tether attachment point may be moved forwards or backwards in order to have an effect on the wing stability margin. For example, in gusty condition it may be desirable to have increased stability. In such a case, the attachment point may be moved further forward of the center of pressure of the airfoil.

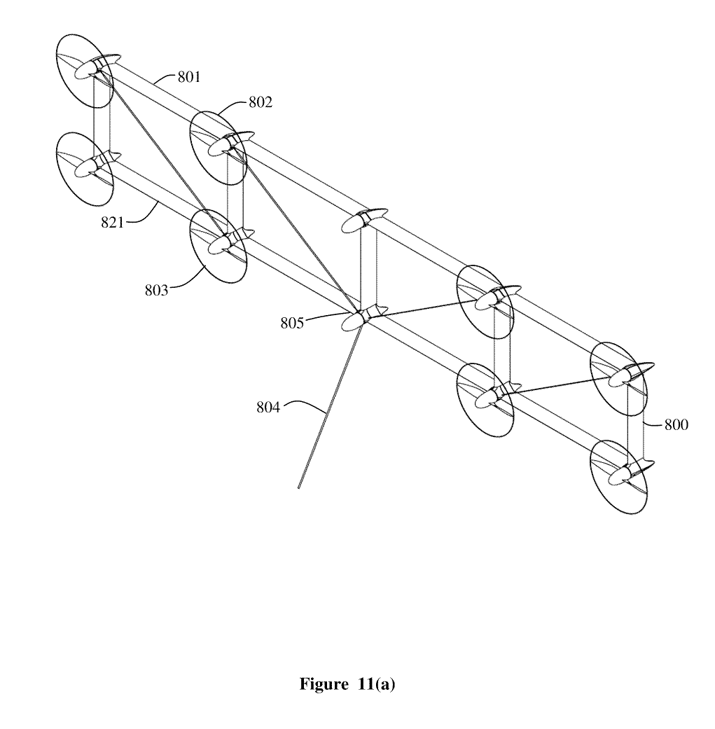

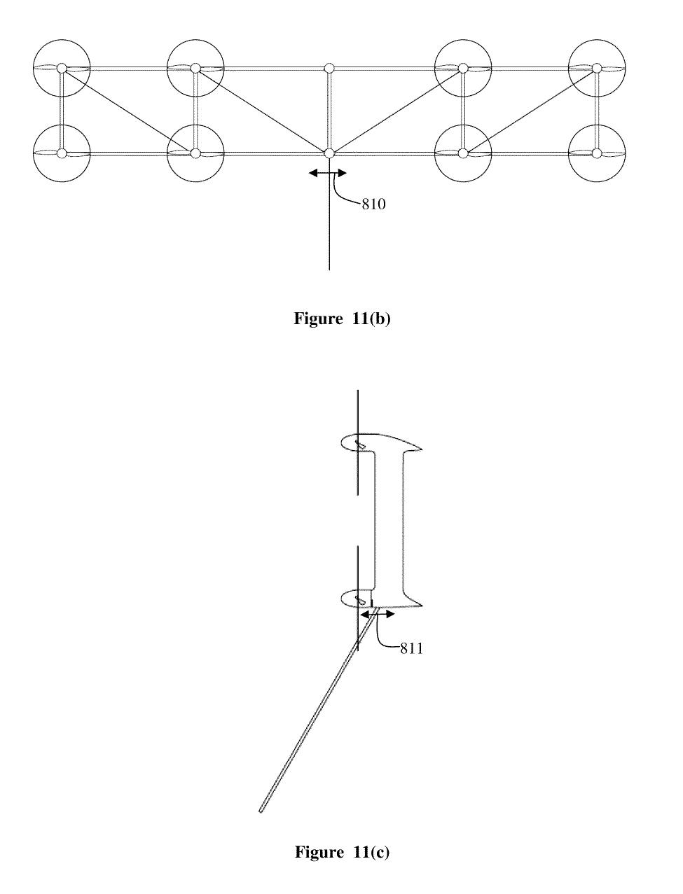

FIGS. 11(a)-11(c) illustrate a dual wing power generation system 800 according to some embodiments of the present invention. A tether 804 may be attached to the flying structure at a tether attachment point 805. The upper airfoil 801 may have a plurality of turbine driven electrical generators 802, and the lower airfoil 821 may have a plurality of turbine driven electrical generators 803. In some embodiments, the tether attachment point 805 is adapted to move the attachment point relative to the overall flying structure. The available movement may be in one axis, two axis, or three axis. In some embodiments, the tether attachment point 805 may use a two axis plate assembly which allows for differential motion using internal lead screws. In some embodiments, the tether attachment point may be moved in the range of 1 cm to 1 meter. For roll control, the tether attachment point may be moved side-to-side 810. For pitch control (and for stability as mentioned below), the tether attachment point may be moved front to back 811.

In some embodiments, the tether attachment point may be moved to a preferred position or positions for vertical take-off of the flying structure. For example, if the flying structure is laying on its back with its leading edges facing upward, it may be advantageous to move the tether attachment point forward relative to the wing (upwards in the vtol configuration) so that cross wind during the take-off does not destabilize the flying structure.

Although some embodiments present herein have illustrated aircraft with airborne turbine driven power generators, it is to be understood that the tether attachment point manipulation for control of a flying tethered craft could be used with aircraft without such turbine driven generators.

The present invention has been particularly shown and described with respect to certain preferred embodiments and specific features thereof. However, it should be noted that the above-described embodiments are intended to describe the principles of the invention, not limit its scope. Therefore, as is readily apparent to those of ordinary skill in the art, various changes and modifications in form and detail may be made without departing from the spirit and scope of the invention as set forth in the appended claims. Other embodiments and variations to the depicted embodiments will be apparent to those skilled in the art and may be made without departing from the spirit and scope of the invention as defined in the following claims. Also, reference in the claims to an element in the singular is not intended to mean “one and only one” unless explicitly stated, but rather, “one or more”. Furthermore, the embodiments illustratively disclosed herein can be practiced without any element which is not specifically disclosed herein.

What is claimed is:

1. A method for the control of a tethered flying aircraft, the method comprising the steps of:
flying the aircraft, wherein said aircraft is tethered to the ground; and
moving the position of the tether attachment point at the aircraft relative to the aircraft.

2. The method of claim 1 wherein said aircraft comprises one or more turbine driven electrical power generators.

3. The method of claim 1 wherein the step of moving the position of the tether attachment point comprises moving the tether attachment point side-to-side in order to control roll torque.

4. The method of claim 1 wherein said step of moving the position of the tether attachment point comprises moving the tether attachment point front to back in order to control the pitch of the airfoils.

5. The method of claim 1 wherein said step of flying the aircraft comprised flying the aircraft in a periodically repetitive flight path.

6. The method of claim 3 wherein said step of flying the aircraft comprised flying the aircraft in a periodically repetitive flight path.

7. The method of claim 5 wherein the control of the tethered flying aircraft is controlled by a control system, and wherein said control system receives input from a plurality of sensors mounted on the aircraft.

8. The method of claim 6 wherein the control of the tethered flying aircraft is controlled by a control system, and wherein said control system receives input from a plurality of sensors mounted on the aircraft.

9. An energy generation system configured to capture wind energy, the system comprising:
an aircraft configured to be positioned in air currents enabling the capture of wind energy;
a tether system that anchors the aircraft when it is airborne;
a power system that enables one of:
(i) the harvesting of wind energy from the aircraft transmitted through the tether to the power system, or
(ii) the capture and transmission of electrical energy generated by the aircraft; and
a control system enabling control of the aircraft and optionally other elements of the system;
wherein the aircraft includes a tether attachment site for attaching the aircraft to the tether and a tether positioning system adapted to adjust the position of the tether attachment site relative to the aircraft.

10. The energy generation system of claim 9 wherein the tether positioning system is adapted to adjust the position of the tether attachment site forward or backwards relative to the aircraft.

11. The energy generation system of claim 9 wherein the tether positioning system is adapted to adjust the position of the tether attachment site side to side relative to the aircraft.

12. The energy generation system of claim 10 wherein the tether positioning system is adapted to adjust the position of the tether attachment site side to side relative to the aircraft.
